(19) United States
(12) Patent Application Publication
(10) Pub. No.: US 2026/0192375 A1
(43) Pub. Date: Jul. 9, 2026

(54) ADJUSTABLE MITER BAR ASSEMBLY FOR WOODWORKING TABLE AND RELATED METHODS

(71) Applicant: Katz-Moses Group, LLC, Santa Barbara, CA (US)

(72) Inventors: Jonathan Katz-Moses, Santa Barbara, CA (US); Andrew Klein, Parker, CO (US)

(73) Assignee: Katz-Moses Group, LLC, Santa Barbara, CA (US)

(21) Appl. No.: 19/015,509

(22) Filed: Jan. 9, 2025

(51) Int. Cl. B23D 47/02

(52) U.S. Cl. CPC B23D 47/025

(57) ABSTRACT

An adjustable miter bar assembly configured for temporarily securing a workpiece to a woodworking table miter slot, the adjustable miter bar assembly having a first elongated housing member with a longitudinal slot and a second elongated member slidably received within the slot. The interior surfaces of the housing and slider members are equipped with complementary angled tabs and angled adjustment slots, allowing for precise lateral adjustment of the dimensions of the assembly. This adjustment ensures a snug fit within a miter slot while maintaining longitudinal sliding capability. Embodiments may feature roller bearings on the exterior surfaces to provide smooth movement and reduce friction within the miter slot.

### FIELD OF THE INVENTION

The present invention relates generally to woodworking accessories and tools designed to enhance precision and stability during cutting and shaping operations. More specifically, the invention relates to adjustable assemblies used within miter slots of woodworking tables to secure workpieces for accurate processing. This invention is particularly applicable to systems that require adjustable fitting and smooth sliding capabilities within miter slots.

### BACKGROUND OF THE INVENTION

The use of miter gauges and miter bars is widespread in woodworking, particularly in operations involving table saws and router tables. Miter bars, which typically slide within a T-slot track on the table, are used to guide workpieces through cutting or routing operations at precise angles. However, one of the challenges associated with conventional miter bars and gauges is maintaining a secure and consistent fit within the T-slot, which can be critical for ensuring accuracy in cuts and reducing unwanted movement during operation. Additionally, conventional miter bars often lack the ability to clamp the workpiece or jig securely in place, necessitating additional accessories or setups.

Several attempts have been made to address these issues by improving the design and functionality of miter bars and related components. Some designs incorporate clamping mechanisms that enable the user to lock the workpiece or jig in place relative to the miter bar. However, these prior art solutions often involve complex mechanisms or require separate components that increase setup time and can be cumbersome to use.

### SUMMARY OF THE INVENTION

The present invention provides an adjustable miter bar assembly that operable to engage securely with a T-slot track typically found in woodworking tables, such as table saws and routing tables. The assembly may include a housing member and a slider member that can be slidably adjusted along a longitudinal axis to alter the lateral dimension of the miter bar, ensuring a snug and precise fit within the T-slot.

In some embodiments, the housing member may include a first side equipped with a first plurality of bearings that extend outwardly to make contact with a first side wall of the T-slot, ensuring stable and accurate alignment during use. The second side of the housing member features a slot configured to receive the slider member, which includes a second set of bearings positioned to contact the opposite side wall of the T-slot. The slider member may include angled tabs that interact with the housing member's slot to facilitate lateral adjustments when actuated by adjustment fasteners. These adjustment fasteners may be positioned at the distal and proximal ends of the housing member and may engage with corresponding threaded holes, allowing for precise modification of the width of the assembly by advancing or retracting the slider member. Embodiments of this mechanism effectively eliminate lateral play while sliding along the T-slot, thereby maintaining tight tolerances and enhancing the accuracy of the workpiece or jig when interfacing with a cutting tool.

In some embodiments, the miter bars of the present invention may include one or more alignment and/or calibration features that contribute to its ease of use and precision. For instance, a plurality of threaded holes may be provided along the length of the housing member to receive alignment fasteners. These alignment fasteners can be used to fine-tune the lateral dimension of the miter bar assembly, ensuring a custom fit for various T-slot sizes. In some embodiments, visual markers and/or detents may be integrated into the slider member, providing clear indicators when the assembly is properly aligned, thereby facilitating quick and accurate setup.

In some embodiments, while the miter bar assembly is secured to a workpiece a woodworker may adjust the lateral dimension of the assembly after a workpiece or jig has been attached. In such embodiments, the miter bar assembly may provide continuous fine-tuning to maintain a precise fit within the T-slot to accommodate for any changes or expansions in the workpiece material during a woodworking operation.

Embodiments of the miter bar assembly can be constructed from a variety of materials, depending on the specific application and required durability. In some embodiments, the housing and slider members may be fabricated from high-strength materials such as aluminum, hardened steel, or reinforced polymers, which offer a balance of strength, durability, and lightweight characteristics. In some embodiments, the bearings may be roller bearings constructed from wear-resistant materials such as hardened steel or ceramic to ensure smooth operation and extended longevity. Manufacturing of embodiments of the miter bar assembly may involve precision machining techniques such as CNC (Computer Numerical Control) milling to achieve the necessary tolerances and surface finishes for both the housing and slider members. This ensures that all components fit together seamlessly and function as intended. Bearings and fasteners may be assembled using press-fitting or threaded connections, depending on the design requirements.

In some embodiments, additional features may be integrated into the miter bar assembly to enhance its functionality. For example, the housing or slider member may include integrated dust channels or debris guards to prevent the buildup of sawdust or other contaminants within the T-slot, maintaining smooth operation. Additionally, quick-release mechanisms may be incorporated into the adjustment fasteners, allowing for rapid changes in the assembly's configuration without the need for additional tools.

Embodiments of the adjustable miter bar assembly may provide a robust and versatile solution for securing workpieces or jigs within a T-slot track, offering improved accuracy, stability, and ease of use in various woodworking applications. The combination of precision components, durable materials, and design features may ensure that this assembly meets the needs of both amateur and professional woodworkers.

In one aspect, embodiments of the miter bar assembly may include a first elongated housing member with a distal end, a proximal end, an exterior surface, and an interior surface. One side of the first elongated housing member may feature a longitudinal slot running between the distal and proximal ends, and may be equipped with a pair of adjustment fasteners (e.g., set screws) positioned at opposite ends. A second elongated slider member may be received into the longitudinal slot, and may include a distal end, a proximal end, an exterior surface, and an interior surface. The longitudinal slot of the first elongated housing member may have several angled adjustment slots, which extend at an angle relative to the longitudinal slot, while the interior surface of the second elongated slider member may include angled tabs designed to engage with the angled adjustment slots. This engagement allows for the adjustment of the lateral dimension of the assembled housing and slider members, providing a snug fit within a T-slot of a woodworking table while maintaining the ability to slide longitudinally within the slot. The adjustment fasteners at both the distal and proximal ends of the first elongated housing member may engage with the distal and proximal ends of the second elongated slider member, causing it to move laterally within the longitudinal slot to adjust the lateral dimension of the assembly.

In another aspect, embodiments of the miter bar assembly may include a plurality of roller bearings on the exterior surfaces of both the first elongated housing member and the second elongated slider member and may be operable to contact the side walls of the T-slot in a woodworking table. The first elongated housing member may also include a series of threaded holes along its length, configured to receive alignment fasteners, which have a shank and a threaded portion. These alignment fasteners may protrude from the housing and are operable to temporarily secure a (wooden) workpiece. The assembly may further include a series of through holes along the length of the first elongated housing member, each of which may receive a threaded fastener to fixedly secure the housing to the workpiece.

It is another aspect, embodiments of the present invention provide methods for securing a (wooden) workpiece to a (wood) working table, where the table includes a miter slot that may extend parallel to the table's longitudinal axis, and where an adjustable miter bar assembly is positioned within the miter slot. The miter bar assembly may include a first elongated housing member with a longitudinal slot and a plurality of wedged adjustment slots on its interior surface, and a plurality of roller bearings on its exterior surface. The longitudinal slot may receive a second elongated slider member that includes wedge tabs on its interior surface and roller bearings on its exterior surface. The wedge tabs may engage with the wedged adjustment slots to allow for adjustment. The lateral dimension of the assembly may be adjusted by cooperatively moving the adjustment fasteners located at the distal and proximal ends of the first elongated housing member, causing the second elongated slider member to move laterally within the longitudinal slot.

It is a further aspect of the method to provide an adjustable miter bar assembly that includes a plurality of threaded holes securing alignment fasteners with a shank and threaded portion, which may temporarily secure the workpiece. Once secured, the workpiece may be removed from the woodworking table, flipped over so that the adjustable miter bar faces upward, and fixedly secured to the adjustable miter bar using fasteners advanced through the through holes on the miter bar assembly. The workpiece and attached miter bar assembly may then be placed back into the woodworking table and slid along the longitudinal axis of the miter-slot while maintaining a fixed lateral position of the woodwork piece relative to the miter-slot. This configuration allows for performing one or more woodworking operations on the workpiece while maintaining it in a precise and stable position within the miter slot.

It is yet another aspect of the present invention to provide an adjustable miter bar assembly that may also include a first elongated housing member that includes a longitudinal slot and a plurality of wedged adjustment slots on its interior surface and roller bearings on its exterior surface. A second elongated slider member may be received within the longitudinal slot, featuring wedge tabs complementary to the wedged adjustment slots, and roller bearings on its exterior surface. A pair of adjustment fasteners positioned at the distal and proximal ends of the first elongated housing member may cause the second elongated slider member to move laterally within the longitudinal slot, with the wedge tabs engaging the wedged adjustment slots to adjust the lateral dimension of the assembly, ensuring a snug fit within the miter slot of a woodworking table. The first elongated housing member may also include threaded holes along its length, each configured to receive alignment fasteners that temporarily secure a woodwork piece to the adjustable miter bar assembly. Through holes positioned along the length of the housing may receive threaded fasteners to fixedly secure the workpiece. This assembly may be removed from the woodworking table with the workpiece secured to it, flipped over so that the miter bar assembly is positioned above the workpiece, and returned to the miter slot of the woodworking table, where it slides along the longitudinal axis while maintaining a fixed lateral position. During a woodworking operation, the assembly may maintain the workpiece in a precise and stable position within the miter slot.

Further aspects and embodiments will be apparent to those having skill in the art from the description and disclosure provided herein.

It is therefore an object of the present invention to provide adjustable miter bar assemblies having a wedge adjustment mechanism that allows for precise lateral adjustment within a miter slot, ensuring a snug fit within the slot while maintaining the ability to slide longitudinally within the slot.

It is also an object of the present invention to provide miter bar assemblies that enhance stability and accuracy during woodworking operations, by incorporating roller bearings on the exterior surfaces of the assemblies, which are configured to contact the side walls of the miter slot, thereby reducing friction and ensuring smooth, controlled movement.

It is another object of the present invention to provide methods for securely attaching a wood workpiece to a woodworking table via an adjustable miter bar assembly, wherein the assembly can be adjusted for a snug fit within a miter slot and is equipped with features such as alignment fasteners and through holes to temporarily or permanently secure the workpiece to the assembly.

It is another object of the present invention to provide a woodworking accessory that facilitates reversible assembly and precise positioning, allowing a miter bar assembly and attached workpiece to be removed, flipped, and re-secured in a miter slot, thereby maintaining the workpiece in a fixed lateral position during various woodworking operations.

It is another object of the present invention to provide an adjustable miter bar assembly that allows for post-attachment adjustments to the lateral dimension, thereby enabling woodworkers to fine-tune the fit of the assembly within a miter slot even after a plywood top or workpiece has been secured to the assembly.

The above-described objects, advantages, and features of the invention, together with the organization and manner of operation thereof, will become apparent from the following detailed description when taken in conjunction with the accompanying drawings, wherein like elements have like numerals throughout the several drawings described herein. Further benefits and other advantages of the present invention will become readily apparent from the detailed description of the preferred embodiments.

### BRIEF DESCRIPTION OF THE DRAWINGS

FIG. 1 provides a disassembled perspective view of an adjustable mitter bar assembly, according to an embodiment of the present invention.

FIG. 2 provides a perspective view of an assembled adjustable mitter bar assembly housing, according to an embodiment of the present invention.

FIG. 2A provides a close-up view of a distal end of the housing of FIG. 2, according to an embodiment of the present invention.

FIG. 2B provides a close-up view of the center of the housing of FIG. 2, according to an embodiment of the present invention.

FIG. 3 provides a perspective view of an adjustable mitter bar assembly slider, according to an embodiment of the present invention.

FIG. 3A provides a close-up view of a distal end of the slider of FIG. 3, according to an embodiment of the present invention.

FIG. 3B provides a close-up view of the center of the slider of FIG. 3, according to an embodiment of the present invention.

FIG. 4 provides a perspective view of an adjustable miter bar assembly in an extended configuration, according to an embodiment of the present invention.

FIG. 4A provides a close-up view of the center of the adjustable miter bar assembly of FIG. 4, according to an embodiment of the present invention.

FIG. 4B provides a close-up view of the proximal end of the adjustable miter bar assembly of FIG. 4, according to an embodiment of the present invention.

FIG. 5 provides an environmental perspective view of an adjustable miter bar assembly positioned in the track of a table saw, according to an embodiment of the present invention.

FIG. 6 provides an exemplary side view of a pair of adjustable miter bar assemblies positioned in the track of a table saw, according to an embodiment of the present invention.

FIG. 6A provides a close-up end view of one of the adjustable miter bar assemblies positioned in the track of a table saw, as illustrated in FIG. 6, according to an embodiment of the present invention.

FIG. 7 provides a side view of an adjustable mitter bar assembly in an extended configuration, according to an embodiment of the present invention.

FIG. 8 provides a close-up end view of the adjustable miter bar assembly in an extended configuration that engages with the track of a table saw, according to an embodiment of the present invention.

FIG. 9 provides an exemplary side view of a pair of adjustable miter bar assemblies positioned in the track of a table saw and securing a workpiece, according to an embodiment of the present invention.

FIG. 9B provides a close-up end view of an adjustable miter bar assembly positioned in the track of a table saw and engaging with a workpiece, as illustrated in FIG. 9, according to an embodiment of the present invention.

FIG. 10 provides a view of a workpiece secured to a pair of adjustable miter bar assemblies, according to an embodiment of the present invention.

FIG. 11 provides a close-up view of an adjustable mitter bar assembly secured to the workpiece, according to an embodiment of the present invention.

FIG. 12 provides an overhead view of a pair of adjustable miter bar assemblies secured to a workpiece, according to an embodiment of the present invention.

FIG. 13 provides a semi-exploded front view of an adjustable sled rail guide housing, according to an embodiment of the present invention.

FIG. 14 provides a close-up view of the proximal end of the housing in FIG. 13, according to an embodiment of the present invention.

FIG. 15 provides a front view of an adjustable mitter bar assembly in an extended configuration, according to an embodiment of the present invention.

FIG. 16 provides a cross-sectional view of an adjustable mitter bar assembly in an extended configuration about the line A—A of FIG. 15, according to an embodiment of the present invention.

FIG. 17A provides a close-up view of the proximal end of the adjustable miter bar assembly of FIG. 16, according to an embodiment of the present invention.

FIG. 17B provides a close-up view of the distal end of the adjustable miter bar assembly of FIG. 16, according to an embodiment of the present invention.

### DETAILED DESCRIPTION

Reference will now be made in detail to certain embodiments of the invention, examples of which are illustrated in the accompanying drawings. While the invention will be described in reference to these embodiments, it will be understood that they are not intended to limit the invention. To the contrary, the invention is intended to cover alternatives, modifications, and equivalents that are included within the spirit and scope of the invention. In the following disclosure, specific details are given to provide a thorough understanding of the invention. However, it will be apparent to one skilled in the art that the present invention may be practiced without all of the specific details provided.

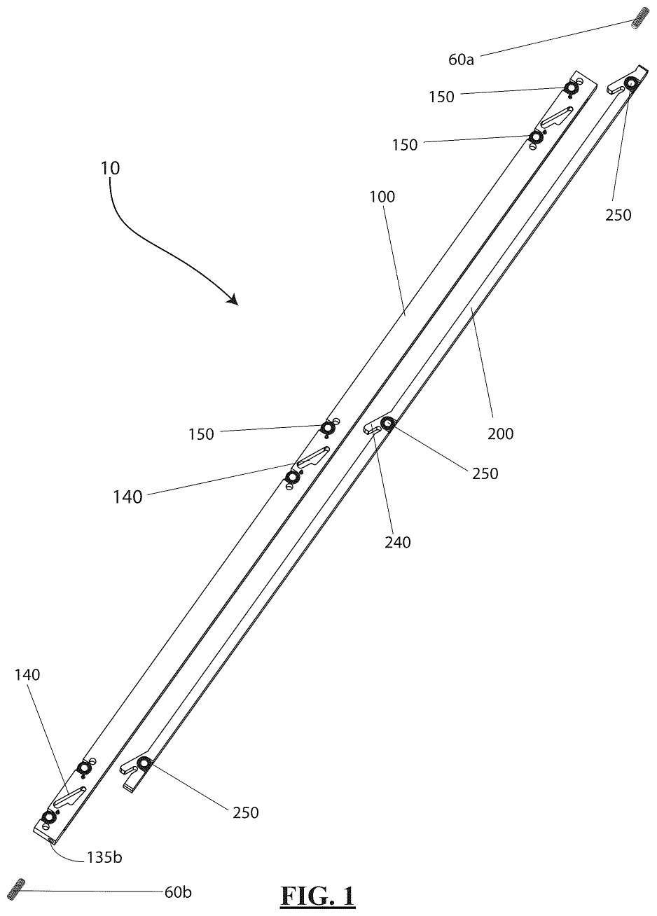

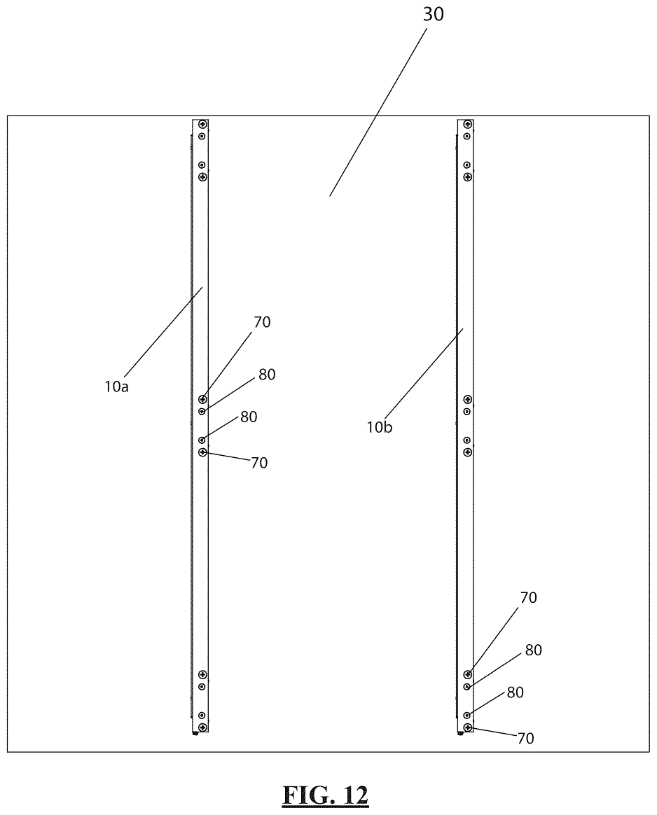

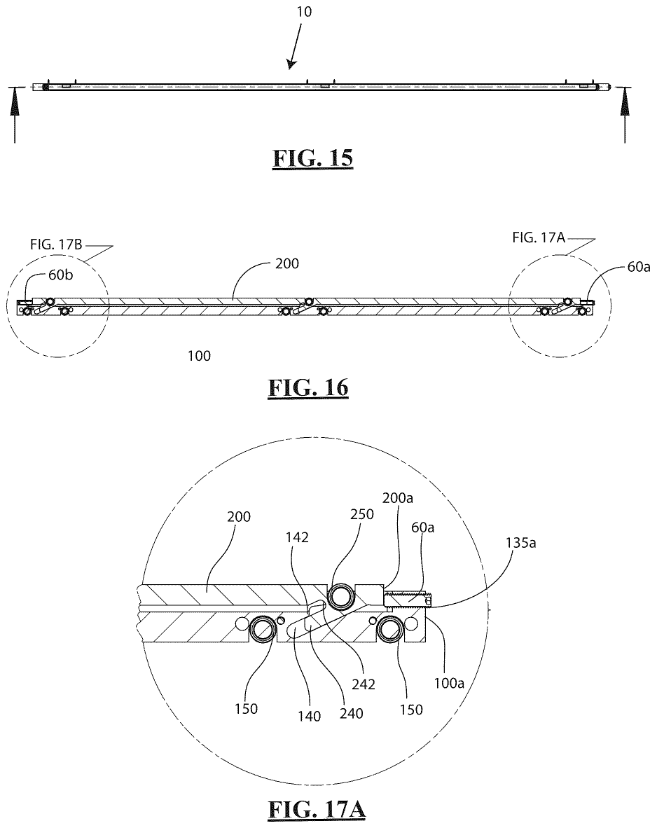

Referring to the drawings, wherein like reference characters designate like or corresponding parts throughout the several views, and referring particularly to FIGS. 1-17, it is seen that the present invention contains various views of an exemplary miter bar assembly that is operable to secure to a woodwork piece or wood jig and slidably engage with a T-slot (e.g., miter slot, T-track) of a woodworking table (e.g., table saw, routing table). The illustrated miter bar assembly may include an adjustable mechanism that is operable to laterally extended to snugly engage with the side walls of a T-slot thereby eliminating lateral play and maintaining tight tolerances of the workpiece or jig when engaging a cutting tool.

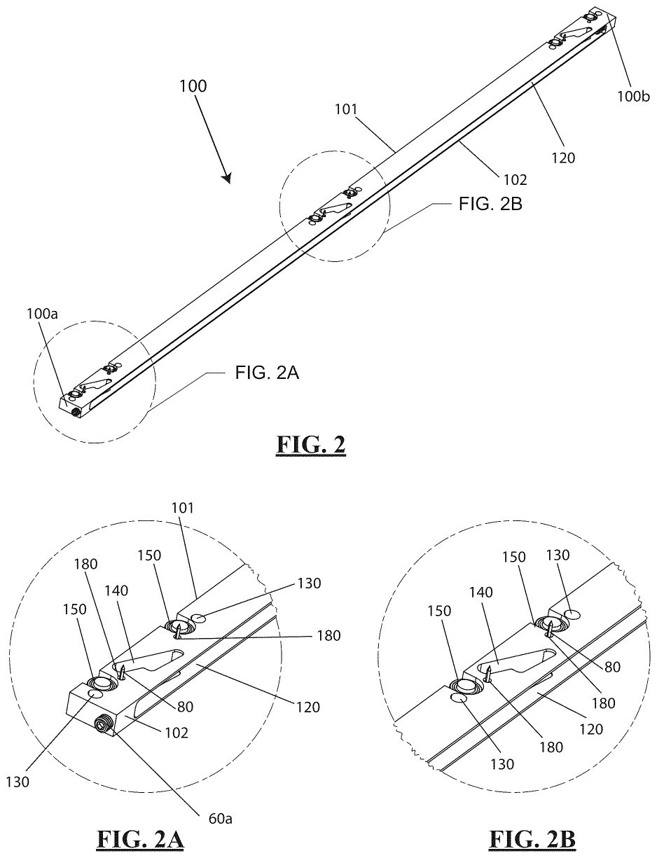

The illustrated embodiment includes an adjustable miter bar assembly 10 that includes a housing member 100 and a slider member 200 that may be slidably adjusted along a longitudinal direction, such that a lateral dimension of the miter bar assembly 10 may be adjusted to snuggly secure in a T-slot. As illustrated in FIGS. 2-2B, the housing member 100 may include a distal end 100a and a proximal end 100b and may have a first side 101 with a plurality of bearings 150, and a slot 120 on a second side 102 that is operable to receive the slider member 200. The bearings 150 may protrude out from the first side 101 such that when properly configured the bearings are in contact with a side wall of a T-slot. The housing member 100 may include a plurality of through holes 130 and threaded holes 180 at various locations along the length of the member 100. Member 100 may also include a plurality of angled slots 140 that are operable to engage with corresponding angled tabs 240 of the slider member 200.

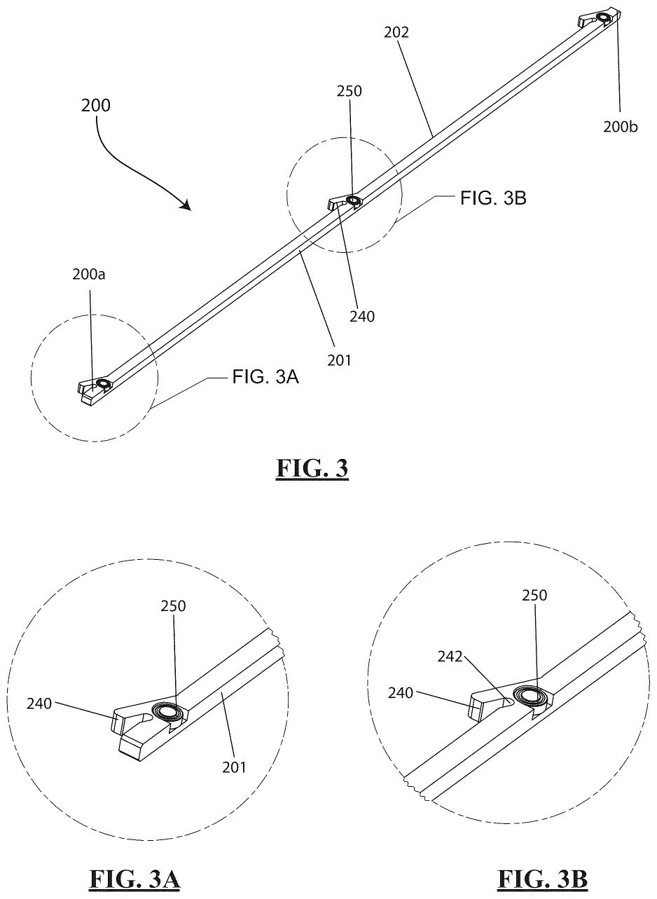

Complementary to the housing member 100, as illustrated in FIG. 3-3B, the slider member 200 may include plurality bearings 250 positioned on a first side 201, and a plurality of angled tabs 240 that extend from a second side 202, that are distributed between a distal end 200a and a proximal end 200b of the slider member. The bearings 250 may extend out from the first side 201 such that when properly configured the bearings 250 are in contact with an opposite side wall of a T-slot. Each angled tab 240 may have a length complementary to the length of its corresponding angled slot 140.

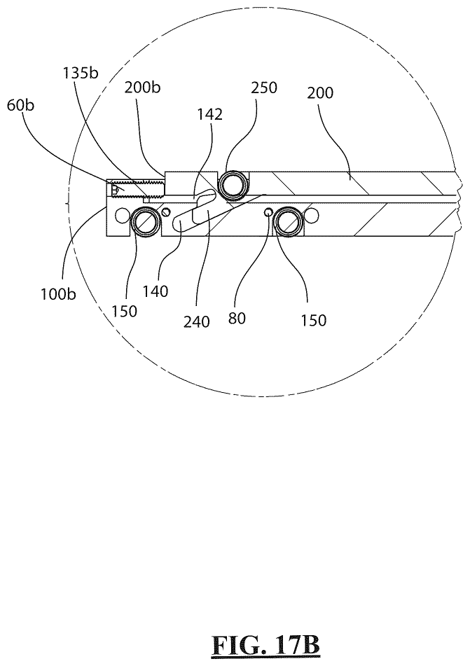

On each end (100a, 100b) of the housing member 100 threaded holes 135a, 135b may be positioned in line with the profile of the slot 120 and may be operable to receive adjustment fasteners 60a, 60b that engage with the ends (200a, 200b) of the slider member 200 to adjust the position of the slider member 200 relative to the housing member 100, thereby adjusting the lateral depth of the miter bar assembly 10. As illustrated in FIGS. 17A-17B, the fastener 60a may be advanced (and fastener 60b retracted) to engage with a distal end 200a of the slider bar 200 thereby moving the angled tabs 240 along the angled path of slots 140 to move housing member 100 apart from slider bar 200 to widen the lateral depth of the assembly 10. This causes the bearings (150, 250) to come into firm contact with the side walls of the T-slot for secure engagement of the assembly therein. Fastener 60b may be advanced (and fastener 60a retracted) to move slider bar 200 and tabs 240 in an opposite direction, reducing the lateral depth of the assembly 10, causing the bearings (150, 250) to pull away from the side walls of the T-slot. It is to be appreciated that the lateral depth of assembly 10 may be adjusted using adjustment fasteners 60a, 60b while the assembly is attached to a workpiece.

As best illustrated in FIG. 17B, the lateral width of the assembly 10 may be expanded using adjustment fastener 60b at the distal end 100b of housing 100. As fastener 60b is threaded into hole 135b, it engages against the distal end 200b of the slider bar 200, pushing angled tabs 240 along the angled paths of slots 140. This movement pushes housing member 100 and slider bar 200 apart in both the lateral and longitudinal directions. Fastener 60b may be advanced until housing member 100 and slider bar 200 have been moved apart a desired distance (e.g., to securely engage the sides of the T-slot). It is to be appreciated that before or during the adjustment of fastener 60b, the opposing adjustment fastener 60a at the opposite end of the assembly 10 must be threaded in the opposite direction in order to allow slider bar 200 to move relative to housing member 100. Once the desired expansion is achieved, both fasteners 60a and 60b should be tightened to maintain the adjusted position. It is to be appreciated that these adjustments using threaded fasteners 60a and 60b may be accomplished before or after the assembly 10 has been attached to a workpiece.

As shown in FIG. 17A, in order to contract the lateral width of the assembly 10 (e.g., for removal from the T-slot)adjustment fastener 60a may be advanced through the threaded hole 135a to engage with the proximal end 200a of the slider bar 200. Advancing fastener 60a against surface 200a of slider bar 200, and withdrawing opposing fastener 60b from surface 200b at the opposite end of slider bar 200, pushes the angled tabs 240 along the angled paths of slots 140, contracting the lateral width of the assembly by moving housing member 100 and slider bar 200 together in both the longitudinal and lateral directions.

In some embodiments, to ensure precise alignment during setup, the miter bar assembly 10 may include several calibration features. The alignment fasteners 80 are positioned at various locations along the length of the housing member 100, allowing the user to make fine adjustments to the lateral dimension of the assembly. These fasteners are operable to engage with the threaded holes 180, enabling the user to dial in the exact fit needed for the specific T-slot being used. Additionally, visual markers or detents may be included along the slider member 200 to indicate when the assembly is properly aligned, aiding in the quick and accurate setup of the tool before use.

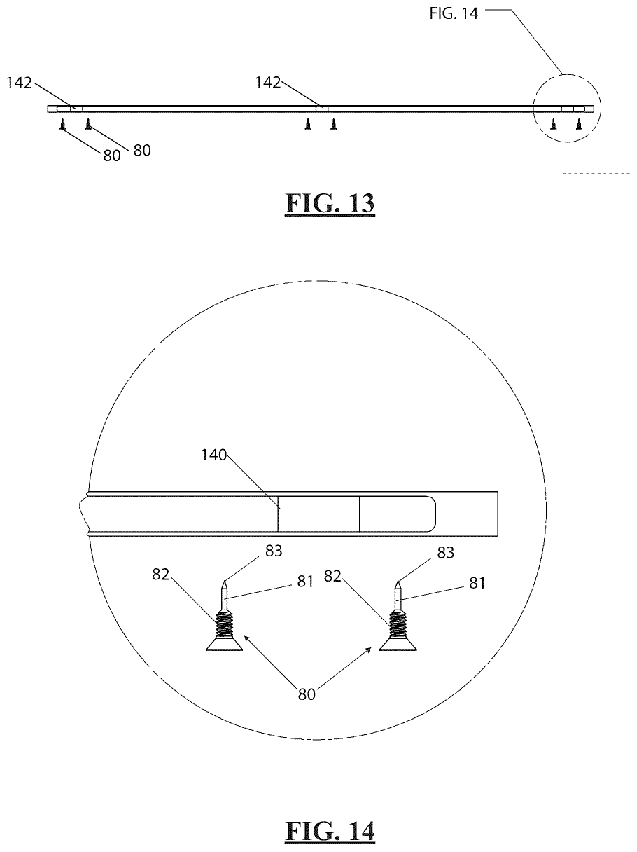

In some embodiments, along the length of the housing member 100 a plurality of threaded holes 180 may be provided and may each receive an alignment fastener 80. As illustrated in FIGS. 13-14 the alignment fastener 80 may include a shank 81 having a point 83 on a first half and a thread ed portion that is operable to engage with the thread holes 180.

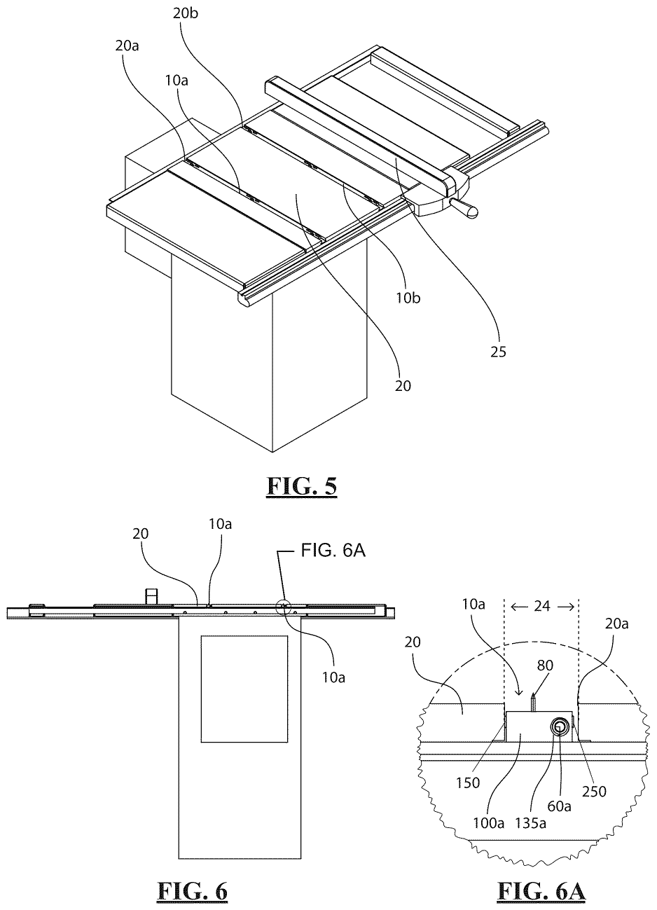

In operation, as illustrated in FIG. 5, a woodworking table 20 may include a pair of T-slots (20a, 20b) for receiving a pair of adjustable miter bar assemblies (10a, 10b). For simplicity, the method will be described herein as to one mitter bar assembly 10a, it being appreciated that the method also applies to the other mitter bar assembly 10b. As shown in FIG. 6A, the T-slot 20b may have a lateral length denoted by reference character 24, and the miter bar assembly 10a may be placed in the slot with the alignment fastener 80 shank 81 positioned upward, and the bearing 150 aligned with at least one side wall of the T-slot 20a. It is seen in FIG. 6A that there is a gap between the slider bearing 250 and the corresponding T-slot side wall 20a. To adjust (expand) the lateral dimension of the miter bar assembly 10a so that it fits snugly in the T-slot, the adjustment fastener 60a is advanced and engages with the distal end 200a of the slider member 200 to adjust the lateral dimension by causing angled tabs 240 to move along angled paths of slots 140, thereby moving bearings 250 outward, as shown in FIG. 7. Once adjusted, the bearings (150, 250) are each in contact with one side wall of the T-slot as illustrated in FIG. 8.

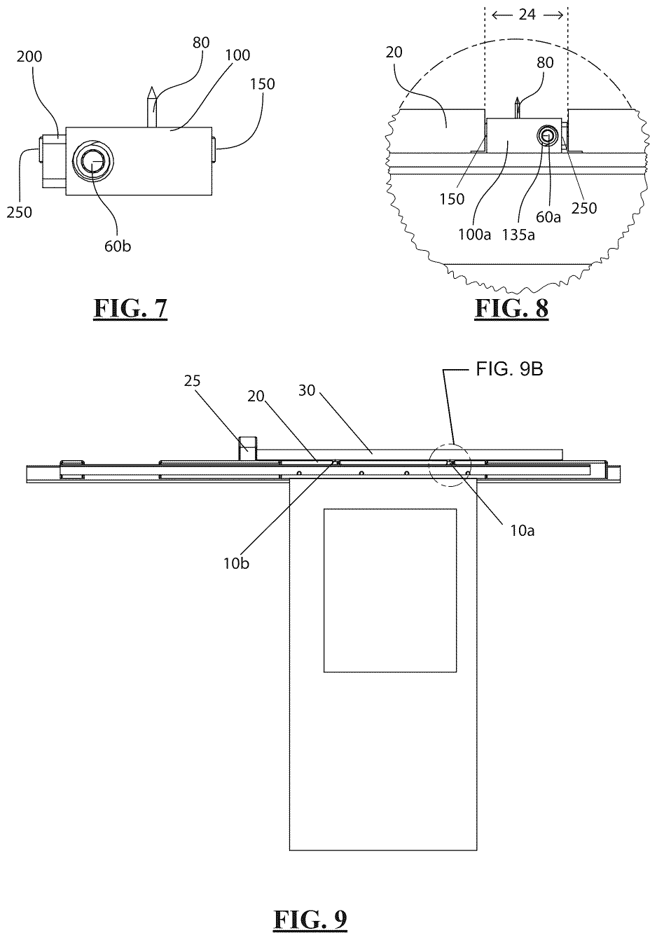

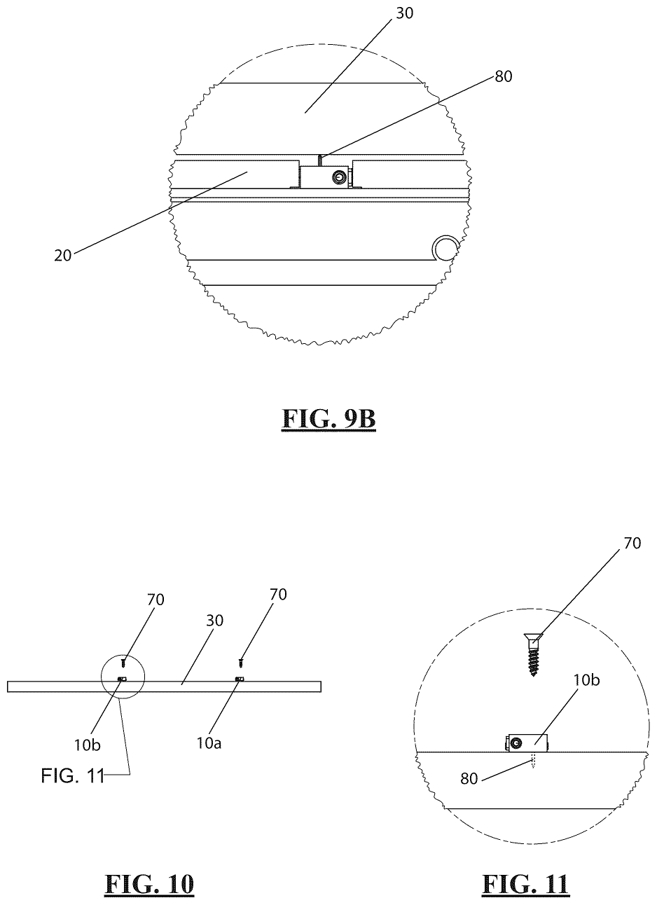

As shown in FIGS. 9 and 9B, a wood workpiece 30 may be positioned above the woodworking table 20, and attached to the miter bar assembly 10a by hammering or pressing (not shown) the wood workpiece 30 onto upwardly protruding alignment fasteners 80. The workpiece 30 and the miter bar assemblies (10a, 10b) may be removed from the table 20 as illustrated in FIG. 10-12. Threaded fasteners 70 may be positioned with each of the through holes 130 and tightened to firmly secure the miter bar assemblies to the workpiece 30 using the plurality of threaded fasteners 70, as shown in FIG. 12. The workpiece 30 may then be placed back in the woodworking table 20, and the miter bars re-inserted into the T-slots, to allow woodworking operations to be performed on the workpiece as desired.

In some embodiments, the adjustable mechanism of the miter bar assembly 10 may be operable to provide a precise fit within the T-slot of a woodworking table, reducing any lateral movement that could affect the accuracy of cuts. The interaction between the adjustment fasteners 60a and 60b and the slider member 200 allows the user to expand or retract the lateral dimension of the assembly. When the fasteners cooperatively moved in the same direction (i.e., when 60b is advanced and 60a is retracted), they push the slider member 200 laterally outward away from member 100, causing the angled tabs 240 to engage more firmly with the side walls of the T-slot. This action ensures that the bearings 150 and 250 on both the housing member 100 and the slider member 200 make consistent contact with the T-slot sidewalls, thereby eliminating any play as the miter bars slide within the T-slot, and maintaining the workpiece in a fixed position relative to the cutting tool. Reversing the cooperative direction of the fasteners (i.e., when 60b is retracted and 60a is advanced), pulls slider member 200 laterally inward toward member 100, causing the angled tabs 240 to release engagement with the side walls of the T-slot.

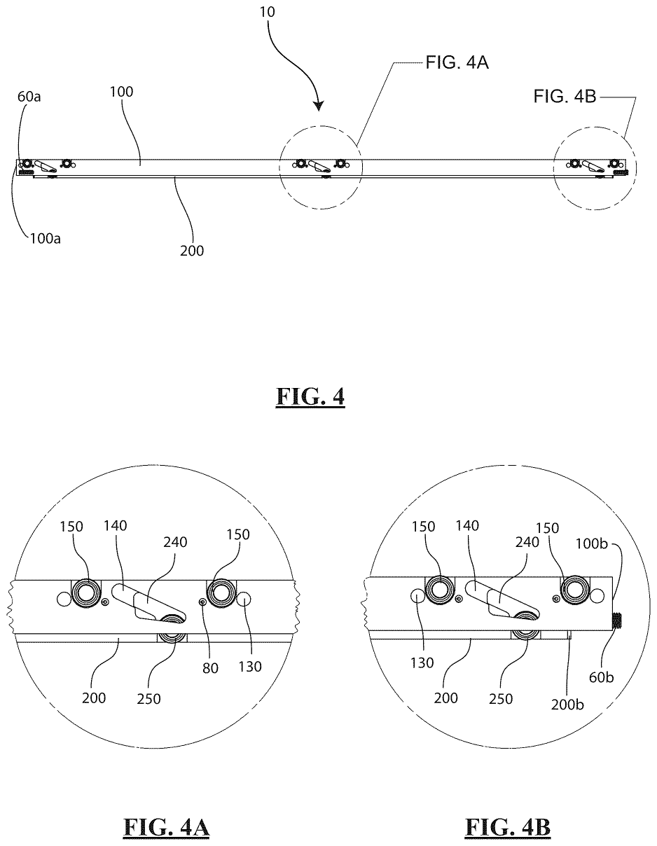

In some embodiments, the miter bar assembly adjustment fasteners 60a and 60b are accessible even after the workpiece 30 is attached to the assembly and allow the woodworker to adjust the lateral dimension of the miter bar assembly to achieve a snug fit within the miter slot 20a, compensating for any variations or expansions in the workpiece material. As illustrated in FIGS. 2 and 4, the adjustment fasteners are positioned on the sides of the housing member 100, providing unobstructed access when a plywood top or workpiece is secured above the assembly. This feature ensures continuous precision and stability during woodworking operations without the need to disassemble the setup.

It is to be understood that variations, modifications, and permutations of embodiments of the present invention, and uses thereof, may be made without departing from the scope of the invention. It is also to be understood that the present invention is not limited by the specific embodiments, descriptions, or illustrations or combinations of either components or steps disclosed herein. The embodiments were chosen and described in order to best explain the principles of the invention and its practical application, to thereby enable others skilled in the art to best utilize the invention and various embodiments with various modifications as are suited to the particular use contemplated. Although reference has been made to the accompanying figures, it is to be appreciated that these figures are exemplary and are not meant to limit the scope of the invention. It is intended that the scope of the invention be defined by the claims appended hereto and their equivalents.

What is claimed is:

1. An adjustable miter bar assembly comprising:
a. a first elongated housing member having a distal end, a proximal end, an exterior surface, and an elongated slot extending along a first side of said exterior surface, wherein a first adjustable fastener is provided at said distal end that extends into said slot, and a second adjustable fastener is provided at said proximal end that extends into said slot, and wherein a plurality of angled slots are provided in the first housing member extending inward from the elongated slot; and
b. a second elongated member operably adapted for slidable engagement with the elongated slot of said first housing member, the second elongated member having a distal end, a proximal end, an inside surface, and an opposite outside surface, wherein a plurality of angled tabs are located on said inside surface, said plurality of tabs corresponding to and operably adapted for slidable engagement with the plurality of angled slots of the first housing member;
wherein the second elongated member is adjustably secured in said elongated slot by said first and second adjustable fasteners.

2. The assembly of claim 1, further comprising a plurality of first bearings located on an opposite side of the exterior surface of said first elongated housing member.

3. The assembly of claim 1, further comprising a plurality of second bearings located on an outside surface of said second elongated member.

4. The assembly of claim 1, further comprising a plurality of first bearings located on an opposite side of the exterior surface of said first elongated housing member, and a plurality of second bearings located on an outside surface of said second elongated member.

5. The assembly of claim 4, wherein the number of bearings of said plurality of second bearings corresponds to the number of angled tabs of said plurality of tabs, and wherein each such bearing is located on said inside surface opposite from each such tab.

6. The assembly of claim 1, further comprising a plurality of threaded holes positioned along the length of the first elongated housing member extending from an upper surface thereof to a lower surface thereof, said threaded holes being operable to receive one of a plurality of alignment fasteners, each such fastener having a threaded portion and a pointed portion.

7. The assembly of claim 6, wherein the pointed portions of said plurality of alignment fasteners protrude out of said first elongated housing member and are operable to temporarily secure to a workpiece.

8. The assembly of claim 1, further comprising a plurality of through holes positioned along the length of said first elongated housing member extending from an upper surface thereof to a lower surface thereof, said through holes each being operable to receive a threaded fastener to fixedly secure said housing member to said workpiece.

9. A method for securing a workpiece to a miter slot of a woodworking table comprising the steps of:
a. positioning an adjustable miter bar assembly in said miter slot, the adjustable miter bar assembly comprising a first elongated housing member slidably engaged with a second elongated member,
i. wherein the first housing member comprises a longitudinal slot along a first side thereof operable to receive said second elongated member, a first adjustable fastener provided at a distal end of the first housing member and extending into said longitudinal slot, a second adjustable fastener provided at a proximal end of the first housing member and extending into said longitudinal slot, and a plurality of angled adjustment slots in said longitudinal slot, and
ii. wherein the second elongated member is slidably engaged with said longitudinal slot and comprises a plurality of angled tabs on an inside surface thereof, the angled tabs being complementary to and adjustably inserted into said plurality of angled adjustment slots, with the first and second adjustable fasteners being movably engaged with opposite ends of the second elongated member;
b. engaging the miter bar assembly with the miter slot by cooperatively moving said adjustable fasteners, causing said plurality of angled tabs to travel along said plurality of adjustment slots, which causes said second elongated member to separate from said first housing member such that the miter bar assembly expands for tight engagement inside said miter slot; and
c. attaching a workpiece to the miter bar assembly by engaging the workpiece with a plurality pointed shank members extending upwardly from said miter bar assembly.

10. The method of claim 9, comprising the additional steps of cooperatively oppositely moving said adjustable fasteners to loosen said miter bar assembly from said miter slot, and removing said workpiece with attached miter bar assembly from said woodworking table.

11. The method of claim 10, comprising the additional steps of turning said workpiece over such that said adjustable miter bar is facing upward, and further securing said workpiece to said adjustable miter bar using a plurality of fasteners advanced through a plurality of through holes extending from an upper surface of said first housing member to a lower surface thereof.

12. The method of claim 11, comprising the additional step of placing said workpiece on said woodworking table by inserting the miter bar assembly secured to said workpiece into the miter slot of said table.

13. The method of claim 12 comprising the additional step of performing a woodworking operation on the workpiece while the adjustable miter bar assembly maintains the workpiece in a precise and stable position within the miter slot.

14. The method of claim 9, wherein said first housing member comprises a plurality of threaded holes extending from an upper surface thereof to a lower surface thereof, each hole operable to receive a threaded portion of one of said plurality of pointed shank members.

15. The method of claim 9, wherein a plurality of first bearings are located on an opposite side of the first elongated housing member.

16. The method of claim 9, wherein a plurality of second bearings are located on an outside surface of said second elongated member.

17. The method of claim 9, wherein a plurality of first bearings are located on an opposite side of the first elongated housing member, and a plurality of second bearings are located on an outside surface of said second elongated member.

18. An adjustable miter bar assembly comprising:
a. a first elongated housing member having a distal end, a proximal end, an exterior surface, and an elongated slot extending along a first side of said exterior surface, wherein a plurality of first bearings are located on an opposite side of the first elongated housing member, wherein a first adjustable fastener is provided at said distal end that extends into said slot, and a second adjustable fastener is provided at said proximal end that extends into said slot, and wherein a plurality of angled slots are provided in the first housing member extending inward from the elongated slot; and
b. a second elongated member operably adapted for slidable engagement with said elongated slot, the second elongated member having a distal end, a proximal end, an inside surface, and an opposite outside surface with a plurality of second bearings located along said outside surface, wherein a plurality of angled tabs are located on said inside surface, said plurality of tabs corresponding to and operably adapted for slidable engagement with the plurality of angled slots of the first housing member;
wherein the second elongated member is adjustably secured in said elongated slot by said first and second adjustable fasteners.

19. The assembly of claim 18, further comprising a plurality of threaded holes positioned along the length of the first elongated housing member extending from an upper surface thereof to a lower surface thereof, said threaded holes being operable to receive one of a plurality of alignment fasteners, each such fastener having a threaded portion and a pointed portion.

20. The assembly of claim 18, further comprising a plurality of through holes positioned along the length of said first elongated housing member extending from an upper surface thereof to a lower surface thereof, said through holes each being operable to receive a threaded fastener to fixedly secure said housing member to said workpiece.
